(19) United States
(12) Patent Application Publication
(10) Pub. No.: US 2014/0297411 A1
(43) Pub. Date: Oct. 2, 2014

(54) Interest Conversion Into Credits To Be Applied To Merchant Offers

(71) Applicant: James L. Peil, Castle Rock, CO (US)

(72) Inventor: James L. Peil, Castle Rock, CO (US)

(21) Appl. No.: 13/854,812

(22) Filed: Apr. 1, 2013

(51) Int. Cl. G06Q 30/02; G06Q 20/10

(52) U.S. Cl. CPC G06Q 30/0257; G06Q 20/10; G06Q 40/02
USPC 705/14.55

(57) ABSTRACT

This invention relates to systems and methods for managing interest paid by financial institutions and particularly to a system and method where interest is converted into multiplier credits to be applied to merchant offers. The business system and method provides depositors a better value by giving consumers an opportunity to convert all or any portion of their monthly interest into substantially more buying power with merchants. This business system and method provides a website-platform and/or a onlinebanking enrollment form for easy enrollment of customers and merchants. Furthermore, the system and method allows for communication between the financial institutions and the website-platform. There is also the consumer direct model in which there is not a sponsoring financial institution and customers are able to access and convert their interest payments through the use of technology provided by a third party finance data platform that works in conjunction with the current invention's website-platform.

### BACKGROUND OF THE INVENTION

1. Field of the Invention

This invention relates generally to systems and methods for managing interest paid out by financial institutions and particularly to a system and method where bank interest can be converted into offers from merchants of more value then the interest.

2. Description of Related Art

There is approximately 10.6 trillion dollars in deposits in US Banks and Credit Unions despite the record low deposit rates. Collectively in 2011 Banks and Credit Union paid out close to $75 billion dollars in interest on CD's, Money Market, Savings and Checking accounts. Just 6 years ago in a higher rate environment Banks and Credit unions paid out an amount representing almost $372 billion.

To provide depositors a better value the present invention's system and method presents to banks and credit unions depositors an opportunity to convert all or any portion of their monthly interest into substantially more buying power at local, online and national merchants. The present invention's system will allow consumers to re-direct a portion of the billions of annual interest and convert it into potential spending at our participating merchants.

### SUMMARY OF THE INVENTION

It is an object of the present invention to provide depositors a better value by giving depositors an opportunity to convert all or any portion of their monthly interest into substantially more buying power at local, online and national merchants.

It is objects of the present invention to encourage spending to help the economy rather than have the depositor's money depreciate due to inflation being greater than the interest being collected.

It is an object of the present invention to analyze the distribution of interest for each type of bank account and account holder and use this information to target the right offers by the demographics those account types usually represents, the amount of interest paid out and transaction history. This helps the system provide more relevant interest conversion offers.

It is an object of the present invention to provide analytics to our partner merchants so the present system can provide merchants with relevant information on the performance of their interest conversion offer.

The term “bank” as used herein refers also to “credit union” and “other financial institutions”. The term “merchant” as used herein refers to “local” merchant, “online” merchant and “national” merchant.

In an exemplary embodiment of the present invention, there is disclosed a business method and system for converting a percentage of a customers interests paid out by a participating financial institution into buying power at a group interest platform wherein the customer can choose an amount of interest credits to be applied to a single or multiple offers from a single or multiple merchants. The system and method of the present invention further allows customers to let their interest accumulate.

The business method and system of the present invention is a business model which comprises a website-platform and database for merchants to create offers for customers, displaying offers, and for the customers to log in to view their interests/credits and merchants' offers. Customers can enroll to the system through the participating banks and credit unions. The current system's website and platform works in conjunction with the participating banks and credit unions' database systems and pools the interest into a pooled account associated with the system for recognizing a customer's choice in interest converted and reconciling the payments and credits in the system.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart that shows the process for bank and credit unions to enroll customers.

FIG. 2 shows what the online enrollment form includes.

FIG. 3 shows a sample tracking record created in an external core processing software application used by financial institutions that manages its member base and process transactions (More specifically, tracking record can be created in Symitar).

FIG. 4 shows an example of how $5 of interest accumulated in the group interest account can be redeemed into $50 towards purchases and the interest multiplier offers.

FIG. 5 shows an example of how $5 of interest accumulated in the group interest account can be redeemed into $50 towards purchases

### DESCRIPTION OF THE PREFERRED EMBODIMENT

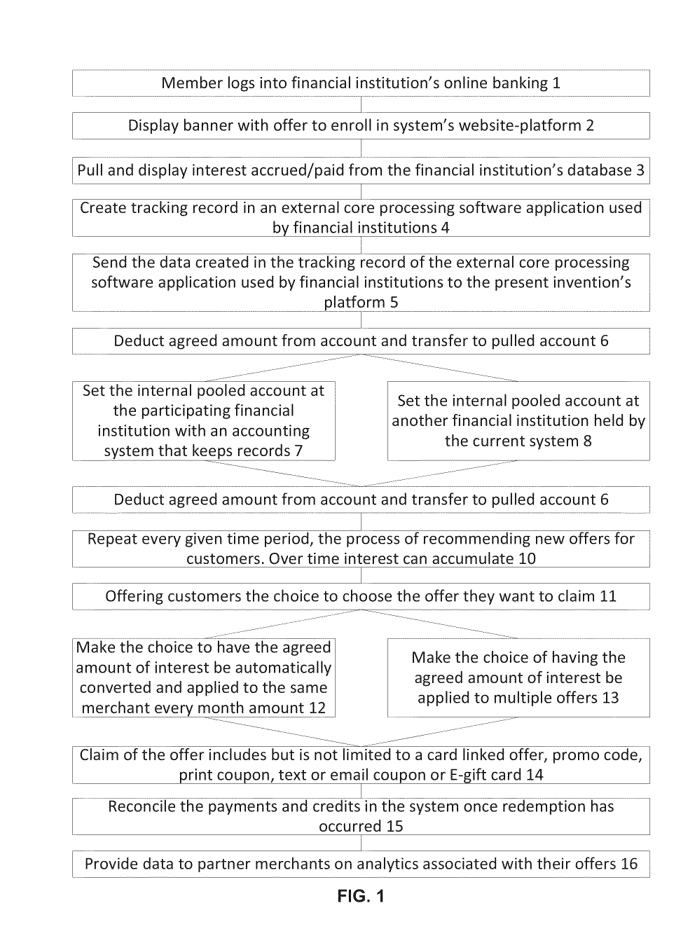

The system will first analyze the distribution of interest that an enrolled bank pays out monthly by each account type. This information is used to help proforma results and target the right offers by the demographics those account types usually represents. Referring to FIG. 1 is a flow chart/block diagram that shows the process for bank and credit unions to enroll customers. The online banking enrollment starts with members logging into their financial institution's online banking 1. On the online banking page, there will be a display banner with the offer to enroll in the present invention's website-platform 2. Customers are either enrolled through a link or form on the financial institution's website that is presented directly within the online banking platform the financial institution is using. The enrollment form automatically pulls interest information from the financial institution's database and presents the consumer an opportunity to convert a portion of that interest into the group interest platform automatically via a transfer or authorized monthly debit. Data is sent to the present invention's website-platform. More specifically, this can be achieved by a RepGen that can be written in the banks core processing system (symitar core example) to pull the interest accrued/paid from all account share information and displayed to member 3. Symitar provides core systems to credit unions. Symitar's flagship product, Episys is a core processing software application used by about 600 credit unions to manage its member base and process transactions. It has its own PowerOn scripting language (most refer to it as RepGen, short for its original name of Report Generator) and its own SymConnect interface which allows access to the core database by Symitar and JHA add-on modules, as well as by third-party add-on providers. In 2002 JHA acquired South Carolina-based CU Solutions, adding the Cruise core processing system to its credit union offering in the Symitar division. This is a Windows-based system for smaller credit unions.

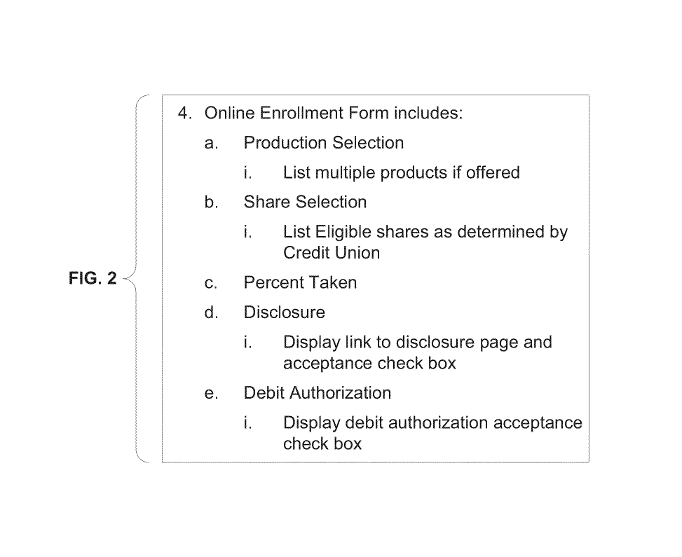

FIG. 2 illustrates an example of an online enrollment form that may include a product selection field where the user can list multiple products offered that they would want their interest to convert into credit for. There is another field for the user to indicate what percent of their interest to be taken out what account and converted into credit to be used towards product offers. A link will be displayed to a disclosure page and acceptance check box. Furthermore, the online enrollment form will display a debit authorization acceptance check box.

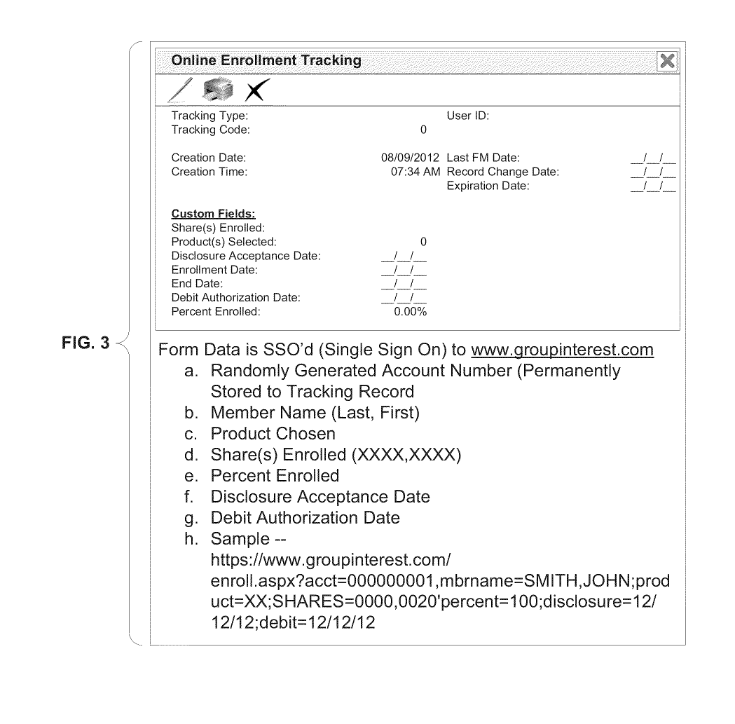

A tracking record is created in an external core processing software application used by financial institutions that manages its member base and process transactions (More specifically, tracking record can be created in Symitar) 4. The form data is used in the corresponding fields as shown in FIG. 3. Fields include the tracking type, tracking code, creation date, creation time, and the custom fields: share(s) enrolled, product(s) selected, disclosure acceptance date, enrollment date, end date, debit authorization date, percent enrolled, etc.

The form data is SSO'd (Single Sign On) to the present invention's website-platform 5 with information like randomly generated account number that are permanently stored to the tracking record, member name (Last, First), the merchant offers chosen by the user, which account the user chose to enroll (XXXX, XXXX), what percent of their interest to be taken out and converted into credit to be used towards merchant offers, the discourse acceptance date, and debit authorization date. Single sign on to said business system allows access control of multiple related, but independent software systems. With this property a user logs in once and gains access to all systems without being prompted to log in again at each of them.

After enrollment the interest is still paid into the account in the usual way but then the agreed amount is deducted from that account and transferred to a pooled account 6. For example, if $1 of interest gets paid in a savings account and the customer agreed to have $1 (100%) deducted then after that $1 is paid it would be deducted from that savings account and transferred to a pooled account. Customers can also choose to have the agreed amount of interest deducted from a different account then the interest is being paid into. For example, in the case of a CD interest payment the customer could choose to have the agreed amount deducted from a checking account. $5 dollars is paid into CD that month but the $5 is deducted from the checking account and transferred to pulled account.

The actual funds can be transferred to an internal pooled account at the participating financial institution with an accounting system that keeps records 7 or to a pooled account held by our invention's system at another financial institution 8. That information is shared securely with the present invention's platform/website where the $1 will show up as $1 of credit to apply to any merchants' offers 9. At a set time period, the process of recommending new offers for customers repeats. Over time interest can accumulate 10.

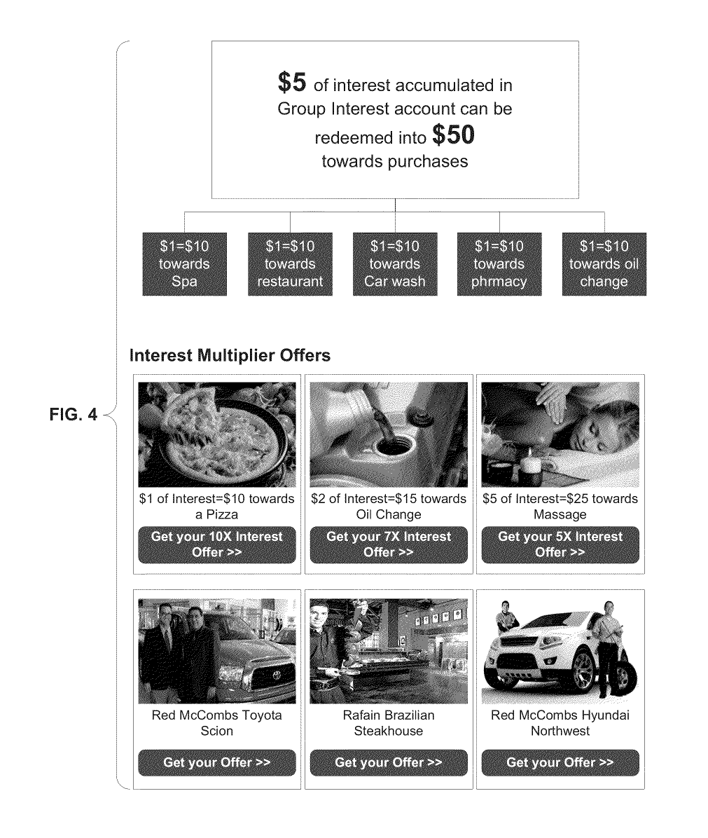

FIG. 4 is an example that shows how $5 of interest accumulated in the group interest account can be redeemed into $50 towards purchases. $1 can be redeemed as $10 towards spa. $1 can be redeemed as $10 towards restaurant. $1 can be redeemed as $10 towards car wash, $1 can be redeemed as $10 towards pharmacy, and $1 can be redeemed as $10 towards oil change. This is termed multiplier offers. Where $1 of interest=$10 towards a pizza is a 10× interest offer.

Back to FIG. 1, the customers simply choose the offer they want to claim 11. Customer can choose to have the agreed amount of interest be automatically converted and applied to the same merchant every month and receive an E-gift card or card linked offer when the interest has accumulated to a predetermined amount 12. For example if a customer chooses only a Target offer. ($5 of interest=$10 towards a Target purchase) then once their interest has accumulated to the $5 amount it will be automatically converted to a e-gift card or card linked offer. Customer can also choose to have the agreed amount of interest be applied to multiple offers 13. Claim of the offer includes but is not limited to access to a coupon site, a card linked offer, promo code, print coupon, text or email coupon, gift card or E-gift card 14. Once redemption has occurred the present invention's system acknowledges, accepts the customer's selected offer, and reconciles the payments and credits in the pooled account 15. The system will provide data to our partner merchants on analytics associated with their offers and will show how many customers and how much interest is accumulating towards their offers if a customer has chosen to auto-convert monthly 16.

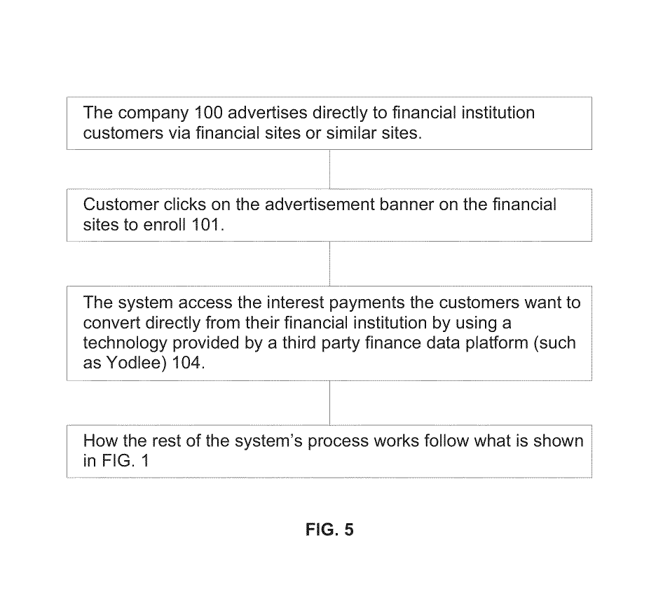

FIG. 5 shows enrollment for a consumer direct model in which there is not a sponsoring bank promoting the solution. The company 100 advertises directly to financial institution customers via financial sites or similar sites (such as BankRate) promoting conversion of interest into more buying power to financial institution customers. Customer clicks on the advertisement banner on the financial sites to enroll 101. The system access the interest payments the customers want to convert directly from their financial institution by using a technology provided by a third party finance data platform (such as Yodlee) 104.

What is claimed is:

1. A business system for converting customer's interests paid out by a participating bank into buying power at a group interest platform comprising:
a first module for enrolling customers, once the customer is logged into online banking the customer enrolling module automatically pulls interest information from the bank database and presents the customer an opportunity to convert an agreed amount of the interest from any customer's bank account into buying power at the group interest platform via an automatic transfer or authorized monthly debit and sends data to the group interest platform;
a pooled account associated with the group interest platform for receiving the agreed amount of interest from the customer's bank account via automatic transfer or authorized monthly debit;
a website-platform for merchants to create offers for customers, displaying offers, and for the customers to log in to view their interests/credits and merchants' offers;
a second module for analyzing the distribution of interest that the enrolled bank pays out monthly by each account type and using this information to help proforma results and targeting the right offers by the demographics those pooled account types usually represent and displaying the recommended merchants' offers to the customers;
a third module for two-way communicating with an external system to pull interest accrued/offer claimed from pooled account;
a database for storing pooled account information received from the third module and storing merchants' offers and customer's offer claimed information, the third module retrieves customer's offer claimed information from the database;
a fourth module for acknowledging and accepting customer's selected offer and reconciling the payments and credits in the pooled account.

2. The business system of claim 1, wherein the pooled account is an internal pooled account held at the enrolled customer's bank which is a participating bank with an accounting system that keeps records.

3. The business system of claim 1, wherein the pooled account is held at a third party bank which is not the enrolled customer's bank.

4. The business system of claim 1, wherein the agreed amount of the interest transferred to the pooled account may be deducted from the account that the interest paid into or from a different account.

5. The business system of claim 1, wherein the second module every given time period repeats the process of recommending new offers for customers.

6. The business system of claim 1, wherein the database of the group interest platform gets updated when the external system's database is updated and the external system's database gets updated when the database of the group interest platform is updated.

7. The business system of claim 1 further comprising single sign on to said business system which allows access control of multiple related, but independent software systems. With this property a user logs in once and gains access to all systems without being prompted to log in again at each of them.

8. The business system of claim 1, wherein claim of the offer includes but not limited to a card linked offer, access to a coupon site, promo code, print coupon, text or email coupon or E-gift card or gift card.

9. The business system of claim 1, wherein the customer can choose to have the agreed amount of interest be applied to multiple offers.

10. The business system of claim 1, wherein the customer can choose to have the agreed amount of interest be automatically applied/converted to the only one same merchant every month and receive an gift card, E-gift card or card linked offer when the interest has accumulated to a predetermined amount.

10. The business system of claim, wherein the customer can choose to have the agreed amount of interest be automatically converted and applied to the same merchant every month and receive an E-gift card or card linked offer when the interest has accumulated to a predetermined amount.

11. The business system of claim 10 further comprising providing data to the partner merchants on analytics associated with their offers to show how many customers and how much interest is accumulating towards their offers if a customer has chosen to auto-convert monthly.

12. The business system of claim 1 further comprising a consumer direct model in which there is no sponsoring financial institution promoting the solution and the business method advertises directly to financial institution customers via financial sites or similar sites promoting the conversion of interest into more buying power.

13. The business system of claim 12 further comprising a costumer clicking on the add banner to access the interest payments they want to convert.

14. The business system of claim 13 further comprising said access is achieved through the use of technology provided by a third party finance data platform to access that information directly from their bank.

15. A business method for converting customer's interests paid out by a participating bank into buying power at a group interest platform comprising steps of:
enrolling a merchant into the group interest platform an interest to credit program wherein the merchant can create offers for customers and displaying offers;
enrolling customers through a first module, the customer enrolling module automatically pulls interest information from the bank database and presents the customer an opportunity to convert an agreed amount of the interest from the any of the customer's bank accounts into buying power at the group interest platform via an automatic transfer or authorized monthly debit and sends data to the group interest platform;
providing a third module for two way communicating with an external system to pull interest accrued/offer claimed from pooled account;
storing pooled account information received from the third module and storing merchants' offers and customer's offer claimed information into a database, the third module retrieves customer's offer claimed information from the database;
analyzing the distribution of interest that the enrolled bank pays out monthly by each account type and using this information to help proforma results and targeting the right offers by the demographics those pooled account types usually represent and displaying the recommended merchants' offers to the customers through a second module;
providing a link on a bank or credit union website or a form that enrolls the user;
enrolling a buyer into the interest to credit program wherein the buyer can search the merchants for best interest to credit value and make a purchase;
receiving the agreed amount of interest from the customer's bank account via automatic transfer or authorized monthly debit into a pooled account associated with the group interest platform;
acknowledging and accepting customer's selected offer and reconciling the payments and credits in the pooled account through a fourth module.
comprising a customer direct model in which there is no sponsoring financial institution promoting the solution and the business method advertises directly to financial institution customers via financial sites or similar sites promoting the conversion of interest into more buying power.
clicking add on the advertisement banner on the financial sites for the customer direct model of the business method provides the customer access to their interest payments they want to convert through the use of technology provided by a third party finance data platform to access that information directly from their bank.

16. The business method of claim 15, wherein the pooled account can be an internal pooled account at the participating financial institution with an accounting system that keeps records.

17. The business method of claim 15, wherein the pooled account is held at a third party financial institution which is not the enrolled customer's financial institution.

18. The business method of claim 15, wherein the customer can choose to have the agreed amount of interest to be applied to multiple offers.

19. The business method of claim 15, wherein the customer can choose to have the agreed amount of interest be automatically converted and applied to the same merchant every month and receive an E-gift card, gift card or card linked offer when the interest has accumulated to a predetermined amount.

20. The business method of claim 15 further comprising single sign on to said business system which allows access control of multiple related, but independent software systems. With this property a user logs in once and gains access to all systems without being prompted to log in again at each of them.
